(19) United States
(12) Patent Application Publication
(10) Pub. No.: US 2015/0265990 A1
(43) Pub. Date: Sep. 24, 2015

(54) DISILOXANE COMPOUNDS AND THEIR USES

(71) Applicant: DOW CORNING CORPORATION, Midland, MI (US)

(72) Inventors: Sung-Hsuen Chao, Seneffe (BE); Alain Hilberer, Recquignies (FR); Don Kleyer, Hemlock, MI (US); Kenneth Zimmerman, Midland, MI (US); Nicolas Ziolkowski, Nivelles (BE)

(21) Appl. No.: 14/438,925

(22) PCT Filed: Oct. 31, 2013
(86) PCT No.: PCT/US2013/067786

§ 371 Date: Apr. 28, 2015

Related U.S. Application Data
(60) Provisional application No. 61/721,230, filed on Nov. 1, 2012.

(51) Int. Cl. B01F 17/54; C04B 16/00; C07F 7/08

(52) U.S. Cl. CPC B01F 17/0071; C07F 7/0852; C07F 7/0879; C04B 16/00

(57) ABSTRACT

A disiloxane having a particular structure is disclosed. A method of preparing the disiloxane is also disclosed. The disiloxane is suitable for numerous end use applications. For example, the disiloxane may be utilized as a wetting agent and/or surfactant. A hydrophobing agent obtainable as a product of the hydrolysis of the disiloxane is also disclosed. The disiloxane may alternatively be utilized in a pesticidal and/or herbicidal composition, a coating, a household care composition, a personal care composition, an emulsion, or an additive for dry mixes.

This relates to a disiloxane compound which upon hydrolysis produces one or more hydrolysis products which function as hydrophobing materials. Such materials may be used in an assortment of applications, not least as wetting additives for use in dry-mix products and dry-mix product compositions for example building materials such as cements and mortars.

Trisiloxane materials are utilized as surfactants and/or wetting agents in aqueous solutions to improve the delivery of active ingredients. However, the trisiloxane compounds may only be used in a narrow pH range, ranging from a slightly acidic pH of 6 to a very mildly basic pH of 7.5. Outside this narrow pH range, the trisiloxane compounds are not stable to hydrolysis undergoing a rapid decomposition and furthermore the decomposition products are not beneficial to the resulting treatment.

Building materials such as cements and mortars are one of the areas of applications in which the above trisiloxanes have been used as additives. Such building materials may contain a large number of additives which are added to modify their properties. These may be added to dry mixed products, wet mixed materials (i.e. after the addition of water) or in hardened state after application. Such additives may include, for example, superplasticizers, accelerating additives, retarders, extenders, wetting agents, dispersants, strengthening agents, antifoams, anti-shrinkage agents, rheology modifiers, and surfactants.

In the case of building materials e.g. cements and mortars there has been a propensity to introduce a wide variety of additives to render the finished product hydrophobic after application and drying. This is because water is the most common cause of serious damage in concrete and rendering and the like. Water is responsible for the ingress of substances having detrimental effects on said concrete etc e.g. salts. Water is also involved in the promotion of the growth of micro-organisms and frost damage in cold periods. Also, heat transmission is directly linked to the amount of moisture in building materials.

A wide variety of materials may be utilised to make building materials such as mortars and concrete and the like hydrophobic. These include oleochemical raw materials, namely metal soaps and silicon-based materials. Whilst the addition of such materials are merited because of a beneficial cost/hydrophobic performance ratio (a dosage of 0.3% is sufficient to attain the required level of hydrophobicity), the presence of such materials can have detrimental effects. Their hydrophobic nature results in poor wetability of the dry-mortar when water is added to the dry-mix because they are strongly hydrophobic and as such insoluble in water which renders them difficult to incorporate in the mortar paste. In practice that means that often the water repellent agents are not fully effective or the batches are not mixed homogenously. Water, soluble soaps such as sodium stearate and sodium oleate have been used as an alternative but whilst their water solubility is an advantage they also have drawbacks in that they cause a greater level of efflorescence (due to the presence of sodium salts), a greater water uptake (i.e. reduced hydrophobicity) and a lower shelf-life than alkali earth and transition metal soaps.”

A preference for the alkali earth and transition metal soaps as hydrophobing materials has therefore lead to the need and use of further additives in such dry-mix compositions including for example surfactants and wetting agents. However, the presence of such surfactants and wetting agents may also be counter-productive as the surfactants have a comparatively short shelf-life compared to many of the other ingredients when mixed with water and can entrain gases to cause foaming. This is because of their instability at high and low pH.

Furthermore, the pH nature of dry-mixes, e.g. concrete and mortars, after hydration (addition of water) dramatically restricts the choice of suitable surfactants and wetting agents. For example, whilst the wetting properties of trisiloxane based materials is well known to the industry, it is also appreciated that, as discussed in column 1 of U.S. Pat. No. 7,935,842, “the trisiloxane compounds may only be used in a narrow pH range, ranging from a slightly acidic pH of 6 to a very mildly basic pH of 7.5. Outside this narrow pH range the trisiloxane compounds are not stable to hydrolysis and undergo a rapid decomposition”. U.S. Pat. No. 7,652,072 describes a selection of disiloxane surfactant compositions that exhibit resistance to hydrolysis over a wide pH range, more particularly to hydrolysis resistant disiloxane surfactants having a resistance to hydrolysis of from a pH of about 3 to a pH of about 12.

Accordingly, there is provided herein a disiloxane having the following structure

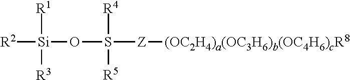

Where R¹, R³, R⁴ and R⁵ are each independently selected from the group consisting of monovalent hydrocarbon radicals having 1 to 4 carbon atoms, substituted monovalent hydrocarbon radicals having 1 to 4 carbon atoms, aryl, and a hydrocarbon group of 6 to 20 carbon atoms containing an aryl group; R² is selected from a branched or linear hydrocarbon group consisting of 7 to 15 carbons, a substituted branched or substituted linear hydrocarbon group consisting of 7 to 15 carbons an optionally substituted aryl group, and an alkyl hydrocarbon chain of 4 to 9 carbons having one or more aryl substituents of 6 to 20 carbon atoms or a branched or a linear hydrocarbon group consisting of 1 to 6 carbons when R¹ and R³ are independently an aryl group, or a hydrocarbon group of 6 to 20 carbon atoms containing an aryl group;
Z is a linear or branched divalent hydrocarbon radical of from 2 to 10 (inclusive) carbon atoms and R⁸ is selected from the group consisting of OH, H, monovalent hydrocarbon radicals of from 1 to 6 carbon atoms and acetyl and each of the subscripts a, b and c are zero or positive provided that a+b+c≧1.

There is further provided a disiloxane having the following structure

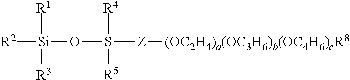

Where R¹, R³, R⁴ and R⁵ are each independently selected from monovalent hydrocarbon radicals having 1 to 4 carbon atoms, aryl, and a hydrocarbon group of 6 to 20 carbon atoms containing an aryl group;
R² is selected from a branched or linear hydrocarbon group of 7 to 15 carbons, a substituted branched or substituted linear hydrocarbon group of 7 to 15 carbons an optionally substituted aryl group, and an alkyl hydrocarbon chain of 4 to 9 carbons having one or more aryl substituents of 6 to 20 carbons or a branched or linear hydrocarbon group of 1 to 6 carbons when R¹ and R³ are independently an aryl group, or a hydrocarbon group of 6 to 20 carbons containing an aryl group;
Z is a linear or branched divalent hydrocarbon radical of from 2 to 10 carbons and R⁸ is selected from OH, H, monovalent hydrocarbon radicals of from 1 to 6 carbons and acetyl and each of the subscripts a, b and c are zero or positive provided that a+b+c≧1.

It is to be understood that the concept “comprising” where used herein is used in its widest sense to mean and to encompass the notions of “include”, “comprehend” and “consist of”. For the purpose of this application “Substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

In one embodiment Z is a linear or branched divalent hydrocarbon radical of from 2 to 6 (inclusive) carbon atoms and furthermore, R⁸ is selected from the group consisting of OH, H, monovalent hydrocarbon radicals of from 1 to 6 carbon atoms and acetyl, but is most preferably OH, and subscripts a≧0, b≧0 and c=0 provided that a+b≧1.

In a further alternative Z is a linear or branched divalent hydrocarbon radical of from 2 to 6 (inclusive) carbon atoms and R⁸ is selected from the group consisting of OH, H, monovalent hydrocarbon radicals of from 1 to 6 carbon atoms and acetyl but is most preferably OH, subscript a>1, subscript b≧0 and subscript c=0. Alternatively, a is ≧3 and b and c are both zero. In a further alternative a and b are both ≧3 with a≧b and c is zero.

In one embodiment R¹ and/or R³ is/are selected from the group consisting of monovalent hydrocarbon radicals having 1 to 4 carbon atoms, an optionally substituted aryl group, and a hydrocarbon group of 4 to 9 carbons containing an aryl group and R⁴ and R⁵ are each independently selected from the group consisting of monovalent hydrocarbon radicals having 1 to 4 carbon atoms, typically methyl or ethyl groups. Alternatively R¹ and/or R³ is/are optionally substituted aryl groups and R⁴ and R⁵ are each independently selected from the group consisting of monovalent hydrocarbon radicals having 1 to 4 carbon atoms, typically methyl or ethyl groups. Where R¹, R³, R⁴ and R⁵ are each independently selected substituted monovalent hydrocarbon radicals having 1 to 4 carbon atoms they comprise at least one C—F bond.

In one alternative R² is selected from a linear or branched hydrocarbon group consisting of 8 to 12 carbons a substituted linear or substituted branched hydrocarbon group consisting of 8 to 12 carbons or an optionally substituted aryl group. In a further alternative, when R² is a substituted branched or substituted linear hydrocarbon group consisting of 7 to 15 carbons R² may comprise at least one C—F bond.

Specifically preferred siloxanes include siloxanes of the following compositions:

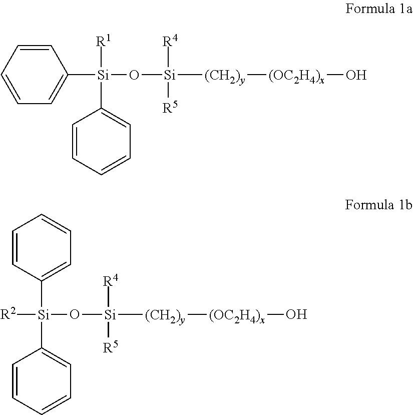

wherein in each case of Formula 1a and 1b respectively R¹, R⁴ and R⁵ as hereinbefore described, y is an integer of from 2 to 7, alternatively y is an integer of from 2 to 5 and x is an integer of from 5 to 10, alternatively x is 6, 7 or 8. Both or either aryl group may be optionally substituted; In formula 1b, of course, R² is a branched or linear hydrocarbon group consisting of 1 to 6 carbons. For example

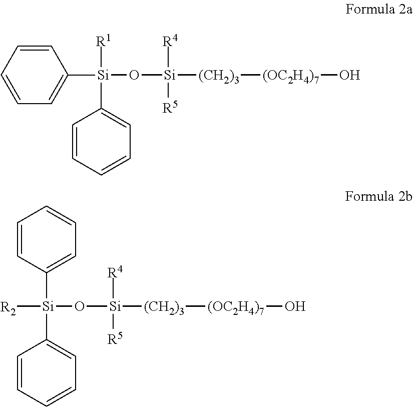

Where R¹, R⁴ and R⁵ are each independently selected from methyl, ethyl, propyl or isopropyl groups.

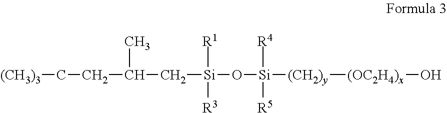

Where R¹, R³, R⁴, R⁵, x and y are as hereinbefore described such as the following:

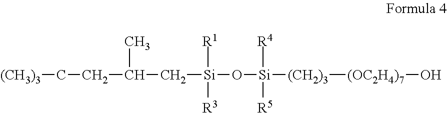

Where R¹, R³, R⁴ and R⁵ are each independently selected from methyl, ethyl, propyl or isopropyl groups;

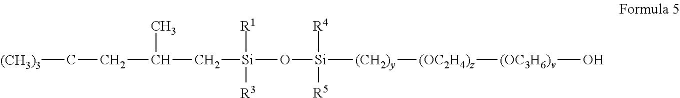

Where y, R¹, R³, R⁴ and R⁵ as hereinbefore described, z is an integer of from 5 to 15, alternatively z is an integer of from 8 to 12 and v is an integer of from 2 to 10, alternatively v is an integer of from 2 to 6. For example

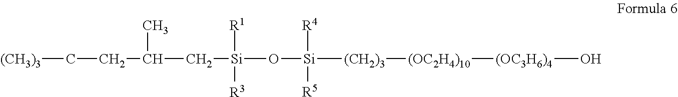

Where R¹, R³, R⁴ and R⁵ are each independently selected from methyl, ethyl, propyl or isopropyl groups.

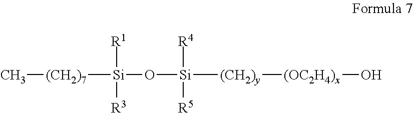

Where R¹, R³, R⁴ and R⁵ as hereinbefore described, y is an integer of from 2 to 7, alternatively y is an integer of from 2 to 5 and x is an integer of from 5 to 10, alternatively x is 6, 7 or 8. For example

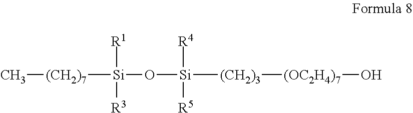

Where R¹, R³, R⁴ and R⁵ are each independently selected from methyl, ethyl, propyl or isopropyl groups.

The disiloxanes described herein may be used as surfactants and/or as wetting materials in compositions but as previously discussed they breakdown in a high pH environment through a hydrolysis reaction. The hydrophobing agents released when the above are hydrolysed are, for sake of example:—

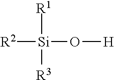

Hence in the case of formula 1a and 2a the hydrophobing molecule after hydrolysis is:—

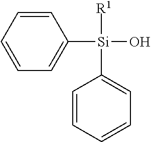

in the case of formula 1b and 2b the hydrophobing molecule after hydrolysis is

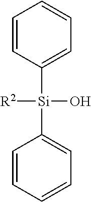

in the case of formulas 3, 4, 5 and 6 the hydrophobing molecule after hydrolysis is:—

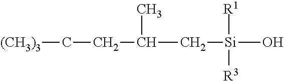

in the case of formula 7 and 8 the hydrophobing molecule after hydrolysis is

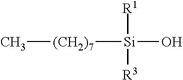

In each case R¹ and R³ are as hereinbefore described.

A method for the preparation of a disiloxane as hereinbefore described comprises reacting a disiloxane of the formula:

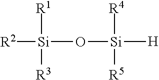

where R¹, R², R³, R⁴ and R⁵ are each as hereinbefore described; with a compound of the formula

CH₂═CH—(CH₂)ₙ—(OC₂H₄)ₐ(OC₃H₆)_{b}(OC₄H₆)_{c}R₈

in which n is 0 to 8 and a, b, c and R⁸ are hereinbefore described; via a hydrosilylation reaction in the present of hydrosilylation catalyst.

A hydrosilylation catalyst is a metal-containing catalyst which facilitates the reaction of silicon-bonded hydrogen atoms of the SiH terminated disiloxane with the unsaturated alkenyl group on the polyoxyalkyllene. The catalysts usually contain one or more of the following metals: ruthenium, rhodium, palladium, osmium, iridium, or platinum.

Hydrosilylation catalysts are illustrated by the following; chloroplatinic acid, alcohol modified chloroplatinic acids, olefin complexes of chloroplatinic acid, complexes of chloroplatinic acid and divinyltetramethyldisiloxane, fine platinum particles adsorbed on carbon carriers, platinum supported on metal oxide carriers such as Pt(Al₂O₃), platinum black, platinum acetylacetonate, platinum(divinyltetramethyldisiloxane), platinous halides exemplified by PtCl₂, PtCl₄, Pt(CN)₂, complexes of platinous halides with unsaturated compounds exemplified by ethylene, propylene, and organovinylsiloxanes, styrene hexamethyldiplatinum, Such noble metal catalysts are described in U.S. Pat. No. 3,923,705, incorporated herein by reference to show platinum catalysts. One preferred platinum catalyst is Karstedt's catalyst, which is described in Karstedt's U.S. Pat. Nos. 3,715,334 and 3,814,730, incorporated herein by reference. Karstedt's catalyst is a platinum divinyl tetramethyl disiloxane complex typically containing one weight percent of platinum in a solvent such as toluene. Another preferred platinum catalyst is a reaction product of chloroplatinic acid and an organosilicon compound containing terminal aliphatic unsaturation. It is described in U.S. Pat. No. 3,419,593, incorporated herein by reference. Most preferred as the catalyst is a neutralized complex of platinous chloride and divinyl tetramethyl disiloxane, for example as described in U.S. Pat. No. 5,175,325.

Ruthenium catalysts such as RhCl₃(Bu₂S)₃ and ruthenium carbonyl compounds such as ruthenium 1,1,1-trifluoroacetylacetonate, ruthenium acetylacetonate and triruthinium dodecacarbonyl or a ruthenium 1,3-ketoenolate may alternatively be used.

### Uses for the Compositions of the Present Invention

The above disiloxanes may be utilised in any suitable applications requiring a wetting agent and/or surfactant but is particularly suitable in applications requiring a hydrophobic coating or body because upon hydrolysis, especially in strongly acidic and strongly basic environments they provide the added advantage of breaking down into one or more hydrophobic molecules. These may include pesticidal and/or herbicidal applications in which compounds as hereinbefore described may be introduced into a spray mixture to provide wetting and spreading on surfaces. The disiloxane compounds may act as a surfactant, which can perform a variety of functions, such as increasing spray droplet retention on surfaces, enhance spreading to improve spray coverage, or to provide penetration of the herbicide. In this case, of course, the hydrophobic properties imparted to the surface may prevent an active ingredient from being washed away by the action of rain or the like.

Such pesticidal and/or herbicidal applications will comprise one or more pesticides and compounds as active ingredients. Optional ingredients might include excipients, co-surfactants, solvents, foam control agents, deposition aids, drift retardants, biologicals, micronutrients, fertilizers and the like. It is to be understood that the term pesticide means any compound used to destroy pests, e.g., rodenticides, insecticides, miticides, fungicides, and herbicides.

Another possible application for the compounds described herein is in relation to coating formulations requiring a wetting agent or surfactant for the purpose of emulsification, compatibilization of components, levelling, flow and reduction of surface defects. Additionally, these additives may provide improvements in the cured or dry film, such as improved abrasion resistance, anti-blocking, hydrophilic, and hydrophobic properties. Coatings formulations may exist as solvent-borne coatings, water-borne coatings and powder coatings. The coatings components may be employed as: architecture coatings; OEM product coatings such as automotive coatings and coil coatings; Special Purpose coatings such as industrial maintenance coatings and marine coatings and hydrophobing coatings which are stored as dry mixes to which a solvent e.g. water is added prior to use.

Other possible applications include for Household care, applications, in pulp (e.g. as surfactants for wood digestion) and other pulp and paper applications and use in textiles.

A further possible application is in personal care applications in which the disiloxane as hereinbefore described comprises per 100 parts by weight (“pbw”) of the total personal care composition comprising the personal care composition and the disiloxane, from 0.1 to 99 pbw, more preferably from 0.5 pbw to 30 pbw and still more preferably from 1 to 15 pbw of the disiloxane and from 1 pbw to 99.9 pbw, more preferably from 70 pbw to 99.5 pbw, and still more preferably from 85 pbw to 99 pbw of the personal care composition.

The disiloxane as hereinbefore described may be utilized in personal care emulsions, such as lotions, and creams. As is generally known, emulsions comprise at least two immiscible phases one of which is continuous and the other which is discontinuous including microemulsions and emulsions of emulsions.

Once the desired form is attained whether as a silicone only phase, an anhydrous mixture comprising the silicone phase, a hydrous mixture comprising the silicone phase, a water-in-oil emulsion, an oil-in-water emulsion, or either of the two non-aqueous emulsions or variations thereon, the resulting material is usually a cream or lotion with improved deposition properties and good feel characteristics. It is capable of being blended into formulations for hair care, skin care, antiperspirants, sunscreens, cosmetics, color cosmetics, insect repellents, vitamin and hormone carriers, fragrance carriers and the like.

The personal care applications where the disiloxane as hereinbefore described and the silicone compositions derived therefrom of the present invention may be employed include, but are not limited to, deodorants, antiperspirants, antiperspirant/deodorants, shaving products, skin lotions, moisturizers, toners, bath products, cleansing products, hair care products such as shampoos, conditioners, mousses, styling gels, hair sprays, hair dyes, hair color products, hair bleaches, waving products, hair straighteners, manicure products such as nail polish, nail polish remover, nails creams and lotions, cuticle softeners, protective creams such as sunscreen, insect repellent and anti-aging products, color cosmetics such as lipsticks, foundations, face powders, eye liners, eye shadows, blushes, makeup, mascaras and other personal care formulations where silicone components have been conventionally added, as well as drug delivery systems for topical application of medicinal compositions that are to be applied to the skin.

In a preferred embodiment, the personal care composition of the present invention further comprises one or more personal care ingredients. Suitable personal care ingredients include, for example, emollients, moisturizers, humectants, pigments, including pearlescent pigments such as, for example, bismuth oxychloride and titanium dioxide coated mica, colorants, fragrances, biocides, preservatives, antioxidants, anti-microbial agents, anti-fungal agents, antiperspirant agents, exfoliants, hormones, enzymes, medicinal compounds, vitamins, salts, electrolytes, alcohols, polyols, absorbing agents for ultraviolet radiation, botanical extracts, surfactants, silicone oils, organic oils, waxes, film formers, thickening agents such as, for example, fumed silica or hydrated silica, particulate fillers, such as for example, talc, kaolin, starch, modified starch, mica, nylon, clays, such as, for example, bentonite and organo-modified clays.

Suitable personal care compositions are made by combining, in a manner known in the art, such as, for example, by mixing, one or more of the above components with the disiloxane. Suitable personal care compositions may be in the form of a single phase or in the form of an emulsion, including oil-in-water, water-in-oil and anhydrous emulsions where the silicone phase may be either the discontinuous phase or the continuous phase, as well as multiple emulsions, such as, for example, oil-in water-in-oil emulsions and water-in-oil-in water-emulsions.

Other products such as waxes, polishes and textiles treated containing disiloxanes as hereinbefore described are also contemplated as are home care applications for example in laundry detergent and fabric softener, dishwashing liquids, wood and furniture polish, floor polish, tub and tile cleaners, toilet bowl cleaners, hard surface cleaners, window cleaners, anti-fog agents, drain cleaners, auto-dish washing detergents and sheeting agents, carpet cleaners, prewash spotters, rust cleaners and scale removers.

However, the present application as discussed above is particularly directed to use as an additive for dry mixes in the construction industry in which the disiloxane as hereinbefore is introduced into a dry mix of cement or render or the like in a liquid form either neat i.e. undiluted or in a composition with a suitable solvent. Alternative the disiloxane can be used as a surfactant in an emulsion utilised to introduce a hydrophobing or other additive into a dry mix of cement or render or the like. The disiloxane will be particularly useful as a wetting agent for hydrophobing agents utilised industrially as hydrophobing agents. The hydrophobing agents which may be used in such dry mixes include, for example, palmitic, stearic or oleic acid salt(s) of ammonia, alkali metals, alkali-earth metals or transition metals or a mixture thereof may be selected from palmitic, stearic or oleic acid salts of zinc, iron, copper, barium, calcium, magnesium, lithium, sodium, potassium, aluminium and ammonia and is preferably selected from ammonium stearate, sodium stearate, lithium stearate, potassium stearate, magnesium stearate, calcium stearate, barium stearate, zinc stearate, aluminium tri stearate, aluminium-di-stearate, aluminium mono stearate, copper stearate, sodium oleate and potassium oleate, calcium oleate and zinc oleate. Most preferably the salt is zinc stearate or calcium stearate. Least preferred of the metal stearates are the alkali metal stearates as residual alkali metal cations in set cementitious material are known to cause efflorescence therein.

It is to be understood that the meaning of stearate should be construed to be anything from a 100% stearate salt where all anions are stearate anions to a commercially available stearate which tends to be a mixture, substantially of the salts of stearic and palmitic acids.

The introduction of the disiloxane as hereinbefore described in dry mixes containing such hydrophobing agents is that the disiloxane acts as a wetting agent when water is introduced into the dry mix in order to make a cement or mortar or the like but once it has hydrolysed the disiloxane has the ability to compliment the other hydrophobing agents to enhance the hydrophobic nature of the resulting concrete or the like. As hereinbefore discussed which will be the case when e.g. water is introduced into a cementitious dry-mix composition, but in this case however at least one of the hydrolysis degradation products of the disiloxanes described herein is/are hydrophobic and thereby have the additional advantage of having a positive effect in the hydrophobing of the cementitious mixture subsequent to their degradation after functioning as part of the wetting agent.

The cementitious material according to the second aspect of the invention may also comprise additional ingredients. These additional ingredients may include sand, filler and other materials traditionally found in cementitious materials, e.g. lime, aggregate, accelerators, air entrainers, pigments, retarders and pozzolanic materials. Preferably the cementitious material is cement, concrete, mortar or grout or the like.

When water is introduced into the dry mix the disiloxanes function initially as wetting agents but gradually degrade because of the basic nature of the environment of the cementitious material via a hydrolysis reaction initiated when water is introduced into the cementitious composition comprising the granulated particles as herein described. However in accordance with the present disclosure at least some of the resulting degradation products, are hydrophobic and therefore having a positive effect in the hydrophobing of the cementitious mixture subsequent to their degradation after functioning as part of the wetting agent.

In each case the above hydrophobic degradation product improves the hydrophobic nature of the resulting concrete or like material by its mere presence after the degradation of the siloxane (C) present in the granulated additives in the cementitious material prior to the addition of water.

In a third aspect of the invention, there is provided a process of imparting to cementitious material a hydrophobing character by mixing into the cementitious material with a disiloxane as hereinbefore described. Mixing may be done by mechanical means or any other appropriate method known in the art.

In a further embodiment there is provided the use of the disiloxanes described in the applications described above as a wetting agent, surfactant and/or hydrophobing agent.

There now follows a series of examples. There are a series of preparations describing how the disiloxanes as hereinbefore described may be prepared subsequent to which are examples of applications for which they may be used. Where used Me is a methyl group.

### EXAMPLES

### Preparation Example 1

### The Preparation of formula 2b

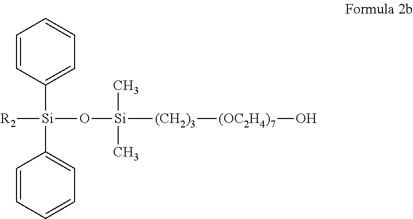

(i) 2 part Synthesis of Diphenyldisiloxane

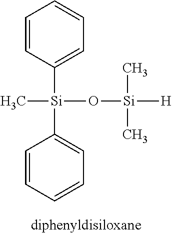 [SMILES: C[SiH](C)O[Si](C)(c1ccccc1)c1ccccc1]

### (ii) Part A

To a 2 L flask was added 84.97 g NaHCO₃ (1 mole) and 795 g deionized water. The contents were stirred to dissolve the sodium bicarbonate before addition of 215.2 g of (Ph)₂MeSiCl, FW 232.5, 0.92 mole. The contents were stirred overnight at ambient temperature before addition of 273 g of deionized water. GC/FID area % analysis of the bottom phase showed 87% (Ph)₂MeSiOH and 6.5% disiloxane. After decanting most of the aqueous layer, the residual contents were transferred to a separating funnel with pentane washes and washed several times with deionized water. The organic layer was transferred to a flask and stripped at atmospheric pressure to a pot temperature of 80° C.

(iii) Part B

The stripped (Ph)₂MeSiOH product from part A above and 210.6 g of tetramethyldisiloxane and trifluoromethanesulphonic acid catalyst (2 drops) were introduced into a 2 L flask. The contents were refluxed for 4 hours before cooling and adding 2.0 g CaCO₃. The contents were filtered through a 5 μm membrane and the filtrate was distilled overhead, 78-80° C. at a pressure of 3 Torr (399.9 Nm⁻²), 73.6 g, 29% overall yield, 95% pure by GC/FID area %. The (Ph)₂MeSiOSi(Me)₂H was characterized by a melting point of 42-43° C., and by GC/MS-EI, m/z (% relative abundance): 89 (6), 121 (6), 135 (15), 165 (6), 179 (base), 180 (20), 181 (12), 193 (14), 194 (31), 195 (22), 196 (6), 197 (7), 241 (7), 257 (81), 258 (21), 259 (8), 272 (M+, 7.8).

(iv) Reaction of Diphenyldisiloxane with Allyl EO₇OH.

The above was undertaken via the hydrosilylation reaction of diphenyldisiloxane+allyl EO₇OH endcapped polyether. The reaction was a batch reaction. After the initial aliquot of Karstedt's catalyst, (10 ppm Pt), no reaction, but upon a subsequent Karstedt's catalyst addition, (10 ppm), an exothermic reaction resulted with a temperature increase from 70° C. to 133° C. The reaction was then checked by FTIR for Si—H and it was found to be zero.

### Preparation Example 2

### The Preparation of Formula 8

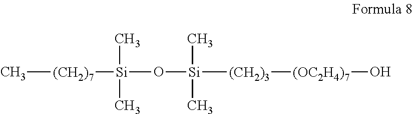

(i) Synthesis of n-octyldisiloxane

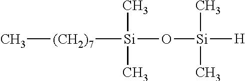

Chemical Structure of n-octyl(Me)₂Si—O—Si(Me)₂-H

A 500 mL, 3 neck flask was equipped with thermometer/thermowatch/N₂ headspace purge, magnetic stir bar, heating mantle, addition funnel containing 147.22 g 1-octene and water cooled reflux condenser with CaSO₄ filled drying tube. The flask was charged with 161.93 g of tetramethyldisiloxane and heated to 70° before addition of a small aliquot of 1-octene followed by 4 drops (0.05 g, 37 ppm Pt) of Karstedt's catalyst. The rate of olefin addition was used to control the pot temperature with the heating mantle removed. After the olefin addition was completed, the heating mantle was used to maintain a pot temperature of 70° C. and 2 aliquots of Karstedt's catalyst were added to complete the hydrosilylation, 4 drops and 6 drops. A 1′ jacketed Vigeraux column was used to distill the product, the product cut was collected at an overhead temperature of 62-70° C. at 3 Torr (399.9 Nm²). The n-octyl(Me)₂Si—O—Si(Me)₂-H was characterized by GC/MS-EI, m/z (% relative abundance): 73 (7), 119 (28), 133 (base), 134 (15), 135 (8), 231 (12).

(ii) Hydrosilylation of n-octyl(Me)2Si—O—Si(Me)2-H with Allyl EO₇OH

The reaction was made in a batch process. The reaction was catalyzed with 6 ppm Karstedt's catalyst at 60° C. and the reaction was exothermic with the temperature rising to 120° C. The reaction was checked by FTIR after one hour and the Si—H was at 0 ppm.

### Preparation Example 3

### The Preparation of Formula 4

(Where R¹, R³, R⁴ and R⁵ are each methyl)

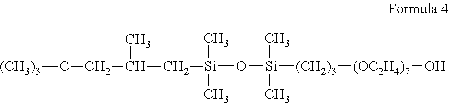

(Where R¹, R³, R⁴ and R⁵ are each methyl)

### (i) Synthesis of Diisobutylene Tetramethyl Disiloxane

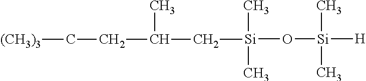

### Chemical Structure of Diisobutylenedisiloxane

A 1 L, 3 neck flask was equipped with thermometer/thermowatch/N₂ headspace purge, magnetic stir bar, heating mantle and water cooled reflux condenser with CaSO₄ filled drying tube. The flask was charged with 267.68 g of tetramethyldisiloxane (2 mol), 119.52 g of diisobutylene (a 3:1 mixture of 2,4,4-trimethyl-1-pentene:2,4,4-trimethyl-2-pentene, since only the terminal isomer will react with a siloxane SiH, ˜0.8 moles of potentially reactive isomer) and 0.79 g of a hydrosilylation catalyst (Pt complex with 1,1,3,3-tetramethyl-1,3-divinyldisiloxane, ˜24% Pt). A spontaneous exotherm increased the temperature of the contents to 26° C. The contents were heated to a set point of 77° C. and two additional aliquots of catalyst were added to push the consumption of 2,4,4-trimethyl-1-pentene, 0.45 g and 0.72 g. The crude product was stripped with just a head giving only 77% area purity (GC/FID) desired product (216.7 g). The fraction was redistilled through a 1′ Vigeraux column at 5 Torr, 57-58° C. yielding 162.4 g (66% yield). The product was characterized by GC/MS-EI, m/z (% relative abundance): 73 (9%), 119 (22), 133 (base), 134 (16), 175 (16), 231 (6), 246 (M+, 0.06).

(ii) Hydrosilylation of Diisobutylene Disiloxane with Allyl EO₇OH

Allyl EO₇OH was metered into the diisobutylene disiloxane maintaining the temperature below 100° C. The 100 ppm of Si—H remained after a one hour hold following the first Karstedt's catalyst addition, (4 ppm), representing a 93% reaction. The reaction was re-catalyzed with 1 ppm additional Karstedt's catalyst, and with an additional 10 wt % of Allyl EO₇OH. The Si—H level was down to 20 ppm after 4 more hours (98.6% reaction). The reaction was deemed complete at this point. The product purity by Si²⁹ NMR is 97%.

### Preparation Example 4

### The Preparation of Formula 6

(Where R¹, R³, R⁴ and R⁵ are each methyl)

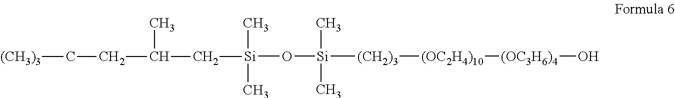

### (i) Synthesis of Diisobutylene Tetramethyl Disiloxane as Discussed in Preparation Example 3 (i).

(ii) (Hydrosilylation of Diisobutylene Disiloxane with Allyl EO₁₀PO₄OH

This reaction was done using the batch process where both components are in the reaction flask. The flask was heated up to 70° C. and was catalyzed with Karstedt's catalyst, (4 ppm). The reaction exotherm resulted in a temperature increase from 70° C. to 110° C. The reaction was complete after one hour with no Si—H visible by FTIR. The product purity by Si²⁹ NMR is 98%.

TABLE 1
Stability of silicone surfactants under alkaline conditions

| | | Surface | |
|---|---|---|---|
| | | Tension | |
| Formula | | at 0.1% | Stability at |
| No | Product | (mN/m) | High pH |
| 2b | 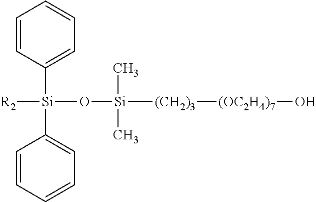 | 32.5 | Slow degradation |
| 8 | 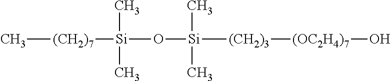 | 39.1 | Slow degradation |
| 4 (R¹, R³, R⁴ and R⁵ are each methyl) | 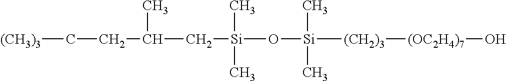 | 29 | Slow degradation |
| 6 (R¹, R³, R⁴ and R⁵ are each methyl) | 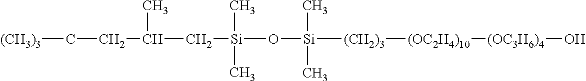 | 24.5 | Slow degradation |

All methyl trisiloxanes and disiloxanes undergo very rapid degradation, even at pH 12 and room temperature. The disiloxanes as hereinbefore described show an increased resistance to hydrolysis but still degrade under basic conditions. However, not only do they provide hydrophobic properties upon breakdown but said disiloxanes when hydrolysed lead to the formation of silanols which show some surface activity themselves, (surface tension 40 mN/M). This means even the degradation products are still active as surfactants.

There now follows a number of examples which illustrate the use of the disiloxanes of the present invention but are not to be construed to limit the scope thereof. All parts and percentages in the examples are on a weight basis and all measurements were obtained at room temperature (typically 20° C.+/−1-2° C.) unless indicated to the contrary.

### Example 1

108 g of dried sand of granulometry between 0-2 mm and 36 g of cement (CEM II 32.5N) are blended for one minute. Then 19 g of mixing water and 0.373 g of disiloxane of formula 2b in Table 1 above are added. The resulting slurry is then poured into a pre-prepared test piece mould measuring 60×60×20 mm. The mould is placed on a vibrating table for 3 minutes and then placed in a closed container at 100% Relative humidity. The test mortar block is de-moulded after 24 hours and allowed to cure in a chamber for a period of 7 days at a temperature of 25° C. and at 100% relative humidity. After 7 days of cure, the mortar block is dried for 24 hours in an oven at 50° C.

### Example 2

108 g of dried sand of granulometry between 0-2 mm and 36 g of cement (CEM II 32.5N) are blended for one minute. Then 19 g of mixing water and 0.367 g of disiloxane of formula 8 in Table 1 above are added. The resulting slurry is then poured into a pre-prepared test piece mould measuring 60×60×20 mm. The mould is placed on a vibrating table for 3 minutes and then placed in a closed container at 100% Relative humidity. The test mortar block is de-moulded after 24 hours and allowed to cure in a chamber for a period of 7 days at a temperature of 25° C. and at 100% relative humidity. After 7 days of cure, the mortar block is dried for 24 hours in an oven at 50° C.

### Example 3

108 g of dried sand of granulometry between 0-2 mm and 36 g of cement (CEM II 32.5N) are blended for one minute. Then 19 g of mixing water and 0.360 g of disiloxane 4 (in which R¹, R³, R⁴ and R⁵ are each methyl) are added. The resulting slurry is then poured into a pre-prepared test piece mould measuring 60×60×20 mm. The mould is placed on a vibrating table for 3 minutes and then placed in a closed container at 100% Relative humidity. The test mortar block is de-moulded after 24 hours and allowed to cure in a chamber for a period of 7 days at a temperature of 25° C. and at 100% relative humidity. After 7 days of cure, the mortar block is dried for 24 hours in an oven at 50° C.

### Reference Example 4a 4b and 4c

3 identical reference samples were tested in comparison and the results for all measurements are found in Table 2 below. 108 g of dried sand of granulometry between 0-2 mm and 36 g of cement (CEM II 32.5N) are blended for one minute. Then 19 g of mixing water is added. The resulting slurry is then poured into a pre-prepared test piece mould measuring 60×60×20 mm. The mould is place on a vibrating table for 3 minutes and then placed in a closed container at 100% Relative humidity. The test mortar block is de-moulded after 24 hours and allowed to cure in a chamber for a period of 7 days at a temperature of 25° C. and at 100% relative humidity. After 7 days of cure, the mortar block is dried for 24 hours in an oven at 50° C.

The resulting mortar blocks were tested for both water uptake and water exclusion and the results are depicted in Table 1 below. The testing method was as follows:

Dry mortar blocks were first weighed (Wdry). The testing device was a plastic basin on the bottom of which synthetic sponges were placed. The basin was then filled with water in such a way that the level of water is set at 1 mm above the top side of the sponge. The water level was maintained constant in order to compensate for any water loss. The dry blocks were then placed on the soaked sponge. This ensures both that the bottom surfaces of the block are at a depth of 1 mm below the water surface and constant wetting of the base of the mortar blocks. The remaining blocks were protruding above the water level. Water absorption by capillarity rise can occur during duration of the experiment. The basin is closed (with a lid) to avoid evaporation of water. The mortar blocks remained left in contact with water for a period of one hour. After one hour each mortar block was cleaned with a fabric to remove excess water from its surface and then reweighed (Wwet). The blocks were then replaced back on the sponge for 2 additional hours (i.e. a total of 3 hours), and reweighed again. The same sequence is then repeated to reach immersion time of 6 hours. Values of water uptake and water exclusion were calculated by use of the following equations wherein:

Water Uptake Percentage (WU %)=(Wwet−Wdry)×100/Wdry

Water Exclusion (WE %)=(WUtreated−WUreference)×100/WUreference

TABLE 2

| | Water uptake (%) | | | Water exclusion (%) | | |
|---|---|---|---|---|---|---|
| | After | After | After | After | After | After |
| | 1 h | 3 h | 24 h | 1 h | 3 h | 24 h |
| reference | 3.80% | 5.96% | 9.28% | | | |
| example 4a | | | | | | |
| reference | 2.41% | 4.27% | 9.07% | | | |
| example 4b | | | | | | |
| reference | 3.59% | 6.05% | 9.04% | | | |
| example 4c | | | | | | |
| example 1 | 0.56% | 2.43% | 8.14% | 82.87% | 55.16% | 10.82% |
| example 2 | 1.01% | 1.71% | 5.30% | 69.09% | 68.56% | 41.99% |
| example 3 | 0.57% | 1.30% | 7.28% | 82.68% | 76.10% | 20.27% |

The water uptakes on the mortar blocks containing the disiloxanes in accordance with the present invention gave significantly improved initial hydrophobicity results compared to the control as the water uptake of those mortar blocks is lower compared to the references.

The table shows the water uptake of mortar blocks modified with different disiloxanes. It is to be understood that low water uptake value (<9% water uptake) were only obtained with disiloxanes, such as those prepared according to the invention.

1. A disiloxane having the following structure 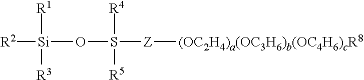
where R¹, R³, R⁴ and R⁵ are each independently selected from monovalent hydrocarbon radicals having 1 to 4 carbon atoms, an aryl group, and a hydrocarbon group of 6 to 20 carbon atoms containing an aryl group;
R² is selected from a branched or linear hydrocarbon group of 7 to 15 carbons, a substituted branched or substituted linear hydrocarbon group of 7 to 15 carbons, an optionally substituted aryl group, an alkyl hydrocarbon chain of 4 to 9 carbons having one or more aryl substituents of 6 to 20 carbons, a branched or linear hydrocarbon group of 1 to 6 carbons when R¹ and R³ are independently an aryl group, or a hydrocarbon group of 6 to 20 carbons containing an aryl group;
Z is a linear or branched divalent hydrocarbon radical of from 2 to 10 carbons, R⁸ is selected from OH, H, monovalent hydrocarbon radicals of from 1 to 6 carbons and acetyl, and each of the subscripts a, b and c are zero or positive provided that a+b+c≧1.

2. A disiloxane in accordance with claim 1 wherein Z is a linear or branched divalent hydrocarbon radical of from 2 to 6 carbons, R⁸ is selected from OH, H, monovalent hydrocarbon radicals of from 1 to 6 carbons and acetyl, and subscripts a≧0, b≧0 and c=0 provided that a+b≧1.

3. A disiloxane in accordance with claim 2 wherein subscript a>1, subscript b≧0 and subscript c=0.

4. A disiloxane in accordance with claim 2 wherein subscript a is ≧3 and b and c are both zero.

5. A disiloxane in accordance with claim 1 wherein R¹ and/or R³ is/are selected from monovalent hydrocarbon radicals having 1 to 4 carbons, an optionally substituted aryl group, and a hydrocarbon group of 4 to 9 carbons having one or more aryl substituents of 6 to 20 carbons and R⁴ and R⁵ are each independently selected from monovalent hydrocarbon radicals having 1 to 4 carbons.

6. A disiloxane in accordance with claim 1 wherein R¹ and/or R³ is/are optionally substituted aryl groups and R⁴ and R⁵ are each independently selected from monovalent hydrocarbon radicals having 1 to 4 carbons.

7. A disiloxane in accordance with claim 1 wherein R² is selected from a linear or branched hydrocarbon group of 8 to 12 carbons or an optionally substituted aryl group.

8. A disiloxane in accordance with claim 1 wherein the disiloxane is selected from one or more of the siloxanes in accordance with Formulas 1, 3, 5 and 7: 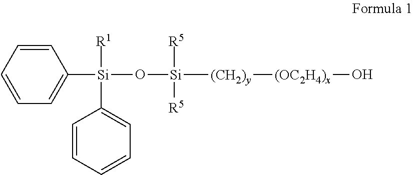
where R¹, R⁴ and R⁵ are defined above, y is an integer between 2 and 7, and x is an integer of from 5 to 10; 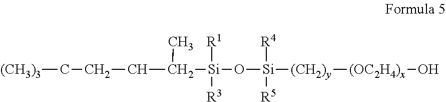
where R¹, R³, R⁴, R⁵ are defined above, y is an integer of from 2 to 7, and x is an integer of from 5 to 10; 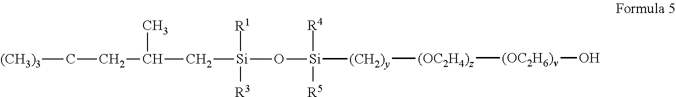
where R¹, R³, R⁴ and R⁵ are defined above, y is an integer of from 2 to 7, z is an integer of from 5 to 15, alternatively z is an integer of from 8 to 12 and v is an integer of from 2 to 10, alternatively v is an integer of from 2 to 6; 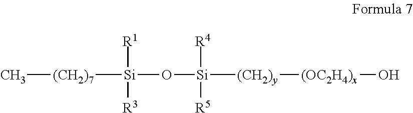
where R¹, R³, R⁴ and R⁵ are defined above, y is an integer of from 2 and 7, alternatively y is an integer of from 2 to 5 and x is an integer of from 5 to 10, alternatively x is 6, 7 or 8.

9. A method for the preparation of a disiloxane in accordance with claim 1, said method comprising reacting a disiloxane of the formula: 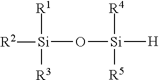
where R¹, R², R³, R⁴ and R⁵ are each independently as defined in claim 1 with a compound of the formula:
CH₂═CH—(CH₂)ₙ—(OC₂H₄)ₐ(OC₃H₆)_{b}(OC₄H₆)_{c}R⁸
in which n is 0 to 8 and a, b, c and R⁸ are each independently as defined in claim 1; via a hydrosilylation reaction in the presence of hydrosilylation catalyst.

10. A disiloxane obtained by the method of claim 9.

11. A wetting agent and/or surfactant comprising the disiloxane in accordance with claim 1.

12. A hydrophobing agent obtained as a product of the hydrolysis of the disiloxane in accordance with claim 1.

13. A pesticidal and/or herbicidal composition comprising a pesticide and/or herbicide and a disiloxane in accordance with claim 1.

14. A coating selected from a solvent-borne coating and a water-borne coating comprising a disiloxane in accordance with claim 1 and a solvent or water.

15. A household care composition comprising a disiloxane in accordance with claim 1 and a suitable carrier.

16. A personal care composition comprising a disiloxane in accordance with any one of claims 1 to 8 and a physiologically acceptable carrier.

17. A personal care composition in accordance with claim 16 for topical application selected from ointments, creams, gels, pastes, foams and aerosols.

18. An emulsion composition having at least two immiscible phases one of which is continuous and the other which is discontinuous, which emulsion comprises a disiloxane in accordance with claim 1.

19. An additive for dry mixes in the construction industry in which the disiloxane in accordance with claim 1 is introduced into a dry mix of cement or render or the like in a liquid form or in a composition with a suitable solvent.
